(19) United States
(12) Patent Application Publication
(10) Pub. No.: US 2009/0004628 A1
(43) Pub. Date: Jan. 1, 2009

(54) Tissue desensitizing system and method

(76) Inventor: Eric J. Knutson, Granite Bay, CA (US)

Correspondence Address: Eric J. Knutson, 5815 Granite Hills Drive, Granite Bay, CA, 95746, US

(21) Appl. No.: 11/820,114

(22) Filed: Jun. 18, 2007

(51) Int. Cl. A61C 19/06

(52) U.S. Cl. 433/215

(57) ABSTRACT

A method and device for controlling the pain of a periodontal ligament injection, and other minor medical and dental procedures. The device desensitizes the tissues utilizing cold, vibration, or both. The method is useful for injections, small biopsies, intraosseous drilling, blood sampling, and so on.

### BACKGROUND

1. Field of Invention

This invention relates to medicine and dentistry, specifically to desensitization of tissues required in association with traumas.

2. Description of Prior Art

In medicine and dentistry, tissues are frequently subjected to traumas, such as periodontal ligament injections, intraosseous injections, general tissue injections, drawing blood, glucose tests, biopsies, lancing abscesses, and so on. Typically the tissues involved are the skin or mucosa epithelial and subepithelial tissues. However, the periosteum, and other tissues may also be involved.

For the descriptions herein, an instrument causing any trauma is called a sharp, and traumas are called punctures. Sharps include needles, aspirators, scalpels, biopsy punches, biopsy brushes, intraosseous perforators, lancets, and so on.

There are several methods of desensitizing tissues prior to puncture. These methods include the use of topical chemical anesthetics, Transcutaneous Electrical Nerve Stimulation (TENS), pressure, vibration, cooling, and so on.

A first method of desensitizing involves applying and removing the desensitizing means from the puncture area immediately prior to the puncture. Examples include the use of DentiPatch (Noven) anesthetic patches, pressing ice or a cold instrument to directly cool the site, and devices of U.S. Pat. Nos. 5,639,238, 5,839,895, 5,873,844 and US Pat Appl 2006/0217636. With anesthetic patches, substantial time is required. With the ice or cold instruments, the method is somewhat awkward.

A second method of desensitizing involves applying cold, vibration, pressure, or other desensitizing means along one side of the puncturing site immediately prior and during the puncture. Examples include pressing on the tissues with a blunt instrument during the puncture, such as a dental mirror handle or a Pressure Anesthesia Device (U.S. Pat. No. 5,171,225).

A third method of desensitizing involves applying pressure to tissues substantially surrounding the puncture area immediately prior to and during the puncture. For example, pressure is maintained on the tissues with a Palatal Anesthesia Device (U.S. Pat. No. 5,088,925) while inserting a needle into the central lumen of the device.

A fourth method of desensitizing involves applying negative pressure to tissues prior and during puncture (U.S. Pat. No. 2,945,496).

A fifth method involves cooling the puncture area prior to puncturing the tissues. A first cooling method involves directing a vapocoolant aerosol spray onto the puncture area prior to a puncture. An example is Freeze aerosol spray (Hagar Worldwide). To avoid frostbite, only moderately cold vapocoolants may be used when spraying directly onto the tissues. A second cooling method involves applying the cold side of a Peltier electrode to the puncture area prior to a puncture.

A sixth method involves placing TENS electrodes near the puncture area and applying current during the puncture (U.S. Pat. No. 5,496,363).

A seventh method of desensitizing involves vibrating the sharp during the puncture (U.S. Pat. Nos. 5,401,242, 5,647,851). For example, a VibraJect (VibraJect LLC) is connected to vibrate a syringe during an injection to activate a pain-gate response (U.S. Pat. No. 6,602,229).

An eighth method of desensitizing involves vibrating the tissues adjacent to the puncture area (U.S. Pat. Nos. 2,258,857, 3,620,209, 6,231,531, & EP1535572).

A ninth method of desensitizing involves applying topical anesthetic gels or liquids to the tissue for a substantial time, and puncturing the tissue through the residual anesthetics.

A tenth method of desensitizing involves stretching the puncture area (US Pat Appl 2006/0211982).

An eleventh method of desensitizing involves pinching the skin surrounding the puncture area (EP1535572)

A twelfth method of desensitizing involves applying heat to the puncture area prior and during the puncture (US Pat Appl 2006/0217636).

A thirteenth method of desensitizing involves applying cold to a puncture area prior and during the puncture with a non-absorbent surface (US Pat Appl 2006/0106363).

The above tissue desensitization methods suffer from one or more of a number of disadvantages:
(a) Pain control achieved is slight to moderate
(b) Method requires excessive time
(c) Method is awkward

### SUMMARY OF THE INVENTION

The invention is a method and device for reducing pain associated with sharps used to puncture tissues, as well as for saving time.

In a typical embodiment, the device comprises an injector handpiece desensitizing system, similar to the self-contained intraosseous injection systems. The system desensitizes the tissue surface with vibrations and/or cooling, and then injects a medicament with a hollow drill bit, such as a local anesthetic.

The part of the system that desensitizes the tissues with vibrations and cooling is called the topical press. Cooling and vibrating of tissues are both known to reduce nerve-pain transmission.

In addition, vibrations can increase the rate of diffusion of a medicament into the tissues. For the purposes of this discussion, it can be assumed that a topical press can vibrate tissues, cool tissues, or both vibrate and cool tissues, unless called a vibrating press or a cooling press.

In another embodiment, the device comprises a needle device desensitizing system with a connected topical press. In another embodiment, a needle device is used with a topical press that comprises a separate brace for vibrating limbs.

For use with non-mechanized sharps like syringes and glucose lancets, topical presses are connected to separate instruments.

### OBJECTS AND ADVANTAGES

Accordingly, several objects and advantages of my invention and process are to provide pain control for tissue puncture:
(a) at a high comfort level
(b) without substantial tissue damage
(d) using a simple method
(e) rapidly

Further objects and advantages are to tissue provide pain control of short duration, so that the tissue sensation is normal soon after the procedure. Still further objects and advantages will become apparent from a consideration of the ensuing description and drawings.

### DRAWING FIGURES

In the drawings, closely related figures have the same number, but different alphabetic suffixes.

FIG. 1 is a perspective view of a drill injector with a slotted topical press-head detail.

FIG. 2 is a perspective view of a drill injector bit.

FIG. 3 is a cutaway view of a drill injector and topical press.

FIGS. 4A to 4E show embodiments of a topical presses.

FIG. 4A is a perspective view of a disc press.

FIG. 4B is a perspective view of a segmented topical press.

FIG. 4C is a cross-section view of a sharp cap.

FIG. 4D is a cross-section detail of a sharp cap lock.

FIG. 4E is a perspective view of a sharp tip press.

FIGS. 5A to 5E show embodiments of topical press covers.

FIG. 5A is a top view of a slotted cover for a slotted press.

FIG. 5B is a top view of a full cover for covering a receiver press.

FIG. 5C is a perspective view of a slot pad for covering the tissue side of a slotted press.

FIG. 5D is a perspective view of a full pad for covering the tissue side of a receiver press.

FIG. 5E is a perspective view of a lumen pad for covering the tissue side of a receiver press.

FIG. 5F is a perspective view of a bandage cover for covering a topical press.

FIG. 6 is a cross-sectional view of an injection device.

FIGS. 7A and 7B show embodiments of a brace press.

FIG. 7A is a perspective view of a brace press.

FIG. 7B is a perspective view of a segmented brace press.

FIGS. 8A to 8C show handheld topical presses.

FIG. 8A is a perspective view of a massager press.

FIG. 8B is a perspective view of a hand instrument topical press with a vibrator

FIG. 8C is a perspective view of a hand instrument topical press.

### REFERENCE NUMERALS IN DRAWINGS

| | | | |
|---|---|---|---|
| 10 | sharp | 12 | injector |
| 14 | handpiece | 16 | slot |
| 18 | actuator | 20 | bit |
| 22 | flutes | 24 | shank |
| 26 | groove | 28 | flat |
| 30 | tube | 32 | bore |
| 34 | orifice | 36 | shoulder |
| 38 | disc | 40 | receiver |
| 42 | segment press | 44 | cap |
| 46 | absorbent | 48 | barrel |
| 50 | first position lock | 52 | third position lock |
| 54 | male lock ring | 56 | tip press |
| 58 | slot cover | 60 | full cover |
| 62 | slot pad | 64 | adhesive |
| 66 | full pad | 68 | lumen pad |
| 70 | bandage | 72 | spot |
| 74 | stack | 76 | backing |
| 78 | needle device | 80 | brace |
| 82 | access | 84 | anchor |
| 86 | segment brace | 88 | massager |
| 90 | handle | | |

### DESCRIPTION

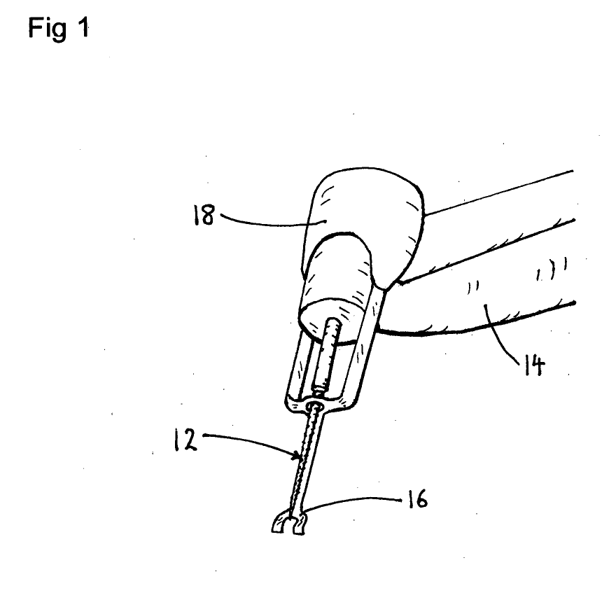

### FIGS. 1 to 8

According to one aspect, the invention provides methods for puncturing tissues with a sharp.

A first tissue puncture method for injecting medicament into the periodontal ligament of a tooth comprises the steps of puncturing the tissues by drilling into the ligament with a drill bit having a central bore, injecting medicament through the bore and into the ligament, and removing the bit from the ligament.

It is preferred that a vibrating and/or cooling topical press desensitizes the tissues prior to an initial puncture. The topical press vibrations are generally in a frequency range of 2 Hz to 200 Hz, but the preferred frequency is between 25 Hz and 45 Hz. The topical press may be cooled by exposure to cold liquids, gasses, or solids, such as cold air in a freezer, refrigerated beads, water cooled to +0.5° C., propylene glycol cooled below 0° C., CO₂ ice, aerosolized CO₂ ice crystals, refrigerants, vapocoolant aerosols, and so on. Suitable vapocoolants have a boiling point between +15° C. and −100° C., with preferred boiling points between +5° C. and −30° C., such as 1,1,1,2-tetrafluoroethane, dichlorotetrafluoroethane, 1,1,1,2,3,3,3-heptafluoropropane, 1,1,1,3,3,3-hexafluoropropane, vapocoolant blends, and so on.

It is preferred that medicament is pumped through the bore while the bit is drilling into the ligament to substantially prevent clogging of the bore with debris.

A second tissue puncture method comprises the steps of supporting a sharp with respect to a topical press, vibrating and/or cooling a tissue puncture area with a topical press, or cover thereof, puncturing the tissues with a sharp at a puncture point within the vibrating and/or cooled puncture area, and withdrawing the sharp from the puncture point.

A third tissue puncture method comprises the steps of supporting a sharp with respect to a topical press, the topical press having a receiving surface having an opening therethrough for passage of the sharp, directly vibrating and/or cooling a tissue puncture point with the topical press or cover thereof, puncturing the vibrating and/or cooling tissues at the puncture point with a sharp, and withdrawing the sharp from the tissues.

A fourth tissue puncture method comprises the steps of supporting a sharp with respect to a topical press surface or cover thereof, directly vibrating and/or cooling a tissue puncture point with the topical press or cover thereof, puncturing the topical press surface or cover thereof, puncturing the vibrating and/or cooling tissue puncture point with a sharp, and withdrawing the sharp from the tissues.

A fifth tissue puncture method comprises the steps of directly vibrating and/or cooling a tissue puncture point, puncturing the vibrating and/or cooling the tissue puncture point with a sharp, and withdrawing the sharp from the tissues.

A sixth tissue puncture method comprises the steps of vibrating a tissue area which substantially encompasses a puncture point, puncturing the vibrating tissue area at the puncture point with a sharp, and withdrawing the sharp from the puncture point.

A seventh tissue puncture method comprises the steps of cooling a tissue area which substantially encompasses a puncture point utilizing an coolant-absorbent surface, puncturing the cooling puncture point with a sharp, and withdrawing the sharp from the puncture point.

A eighth tissue puncture method comprises the steps of cooling a tissue puncture area with a cold topical press or cover thereof, inserting a sharp into and through the topical press and into the cooling tissues of the puncture area, and withdrawing the sharp from the tissues.

For the purposes of this discussion, in general, a sharp used to puncture the tissues is called a sharp 10, including needles, intra-osseous anesthesia drills, lancets, and so on.

According to another aspect of the invention, there is provided a sharp for injecting the periodontal ligament of a tooth, injector 12, as shown in FIG. 1. Injector 12 is a type of sharp 10. Injector 12 is shown connected to a motorized injector handpiece, handpiece 14, of the type shown in US Pat Appl 2006/0106363. A type of topical press, slot 16, is shown connected to handpiece 14 for desensitizing the tissues for injector 12. Slot 16 is a disc-shaped topical press configured with a slot open to the perimeter.

It is preferred that slot 16 is supported with respect to handpiece 14 by a resiliency means. The resiliency means applies pressure on slot 16 away from handpiece 14 and over a limited distance. An example of a resiliency means is a spring, and elastic part, and so on. As such, after slot 16 contacts a puncture area, handpiece 14 may advance toward the tissues by compressing the resiliency means.

Also shown is a cooling and/or vibrating means, actuator 18 for cooling and/or vibrating any topical press, such as slot 16. For handpiece 14, it is preferred that actuator 18 is an offset-weight vibrator with linkage to the handpiece 14 motor. However, actuator 18 may have a dedicated motor and power source. It is preferred that actuator 18 is located in the proximity of the topical press. However, actuator 18 may be located in proximity to the motor, or other locations.

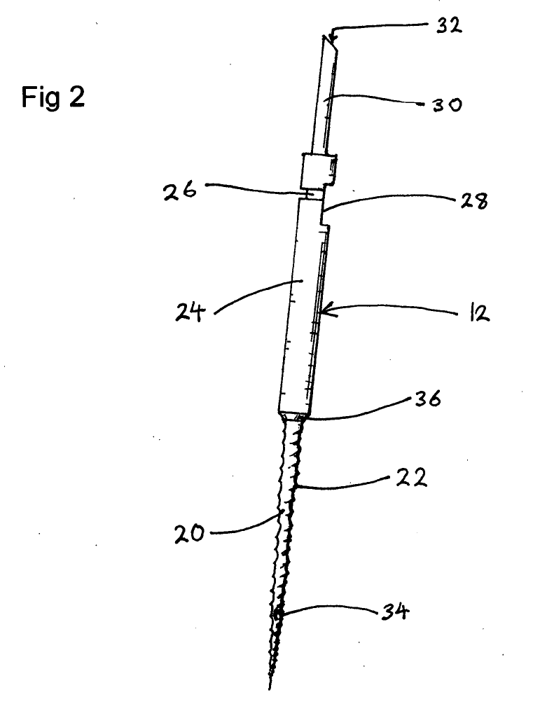

In the preferred embodiment of injector 12, the distal portion of injector 12 comprises a bit, bit 20, for penetrating into the ligament, as shown in FIG. 2. The surface of bit 20 is substantially covered with spiraling serrations, flutes 22. Bit 20 is tapered from a sharp point at the distal tip to the widest point proximal to a cylindrical shank, shank 24. Toward the proximal end of shank 24 is a groove, groove 26, and a drive facet, flat 28, for engaging the drive mechanism of handpiece 14. On the proximal end of shank 24 is a hollow tube, tube 30, for connecting to a medicament source. Tube 30 has a central bore, bore 32. Bore 32 extends continuously from the proximal tip of tube 30 through shank 24, and through at least a portion of bit 20. An orifice, orifice 34, communicates from the surface of bit 20 to bore 32.

It is preferred that bore 32 ends at orifice 34 a given distance from the distal tip of bit 20 so that bit 20 has a solid core in the tip portion to reduce the risk of fracture. However, bore 32 may extend to the distal tip of bit 20. It is preferred that bit 20 is comprised of nickel-titanium alloy, and has a taper between 0.02 and 0.04. However, bit 20 can be of greater or lesser taper, and may be comprised of other materials.

It is preferred that a non-fluted area of enlarged diameter, shoulder 36, is located at the junction of shank 24 and bit 20. In use, bit 20 penetrates the tissue to the level of shoulder 36, and shoulder 36 presses against the gingiva to provide a fluid seal against backpressure leakage of injected medicament from the ligament puncture.

It is preferred that the medicament is onboard handpiece 14. However, the medicament may be located remotely from handpiece 14. It is preferred that medicament is pumped by handpiece 14 by an automatic pump mechanism. However, a manual pump may be used.

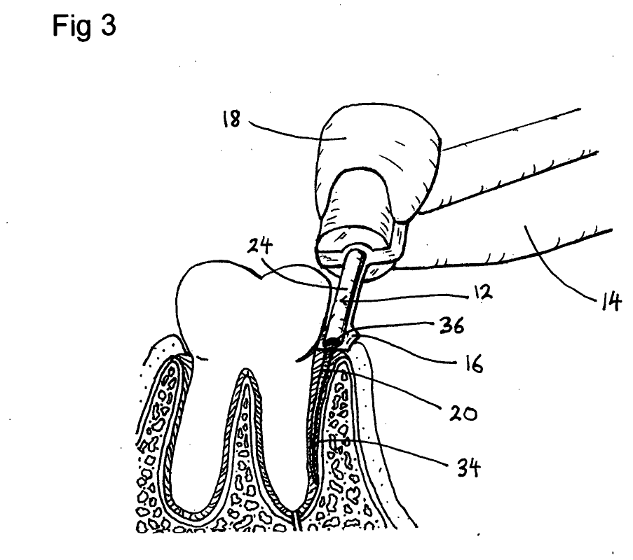

FIG. 3 shows a slot 16 desensitizing the tissues and an injector 12 penetrated into the periodontal ligament of a tooth. Shoulder 36 is shown pressing into the tissues to form a seal to fluid backpressure. An actuator 18 is connected to handpiece 14. The connection of slot 16 to handpiece 14 has slidingly permitted handpiece 14 to move closer to slot 16 as injector 12 penetrates the ligament.

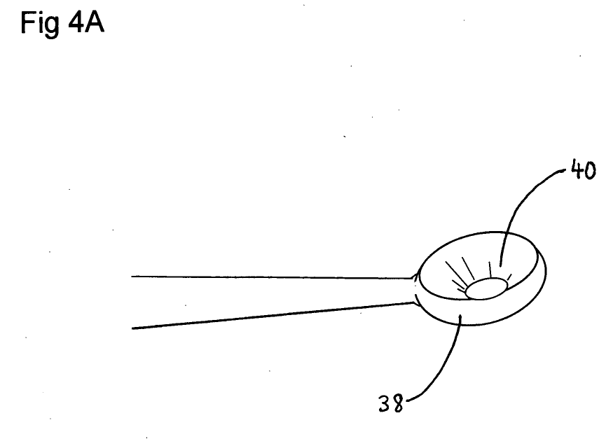

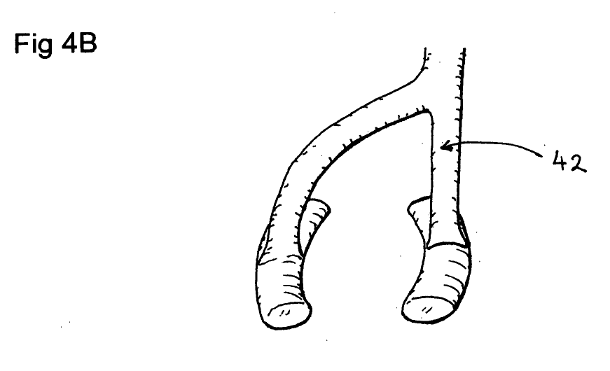

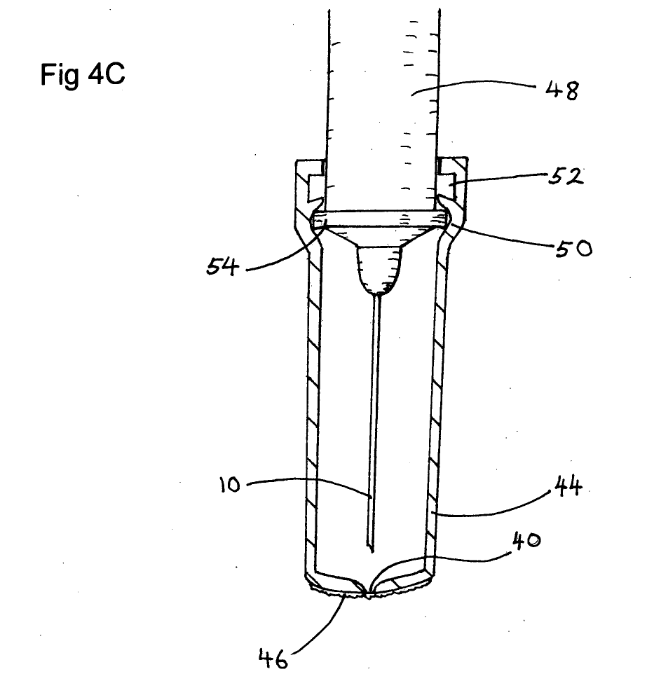

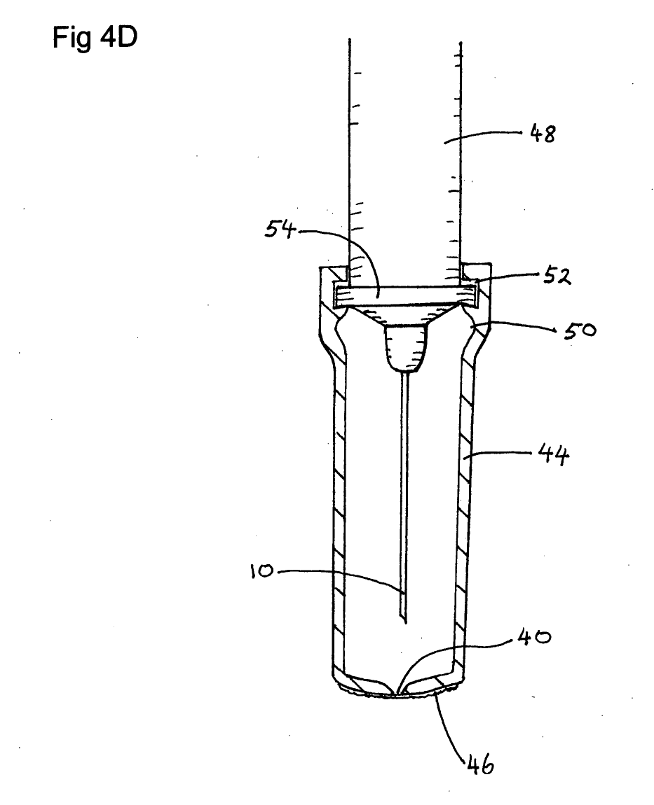

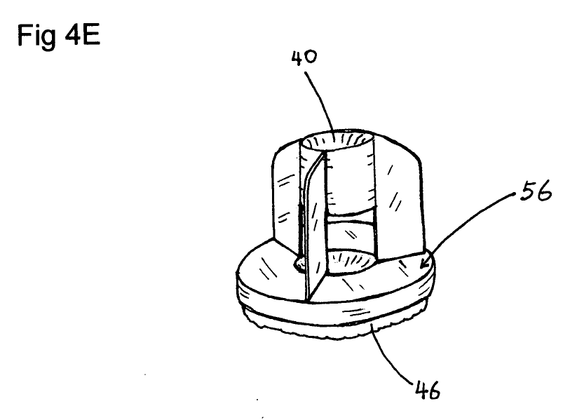

FIGS. 4A to 4F shows embodiments of the topical press. In general, a topical press comprises at least a structural surface, called a tissue surface, configured to contact the surface of the tissues, wherein the topical press may be vibrated and/or cooled while in contact with the tissues to desensitize the tissues.

The topical press may comprise a single unitary press, or may comprise multiple segments. The preferred overall geometrical shape of a topical press varies with the application, such as straight segments, curved segments, a disc, a slotted disc, and so on.

It is preferred that the topical press tissue surface is smooth and convex. However the tissue surface may be substantially flat, concave, irregular, corrugated, porous, fibrous, and so on. It is preferred that the topical press is comprised of stainless steel. However, the topical press may be comprised of other metals, plastic, composites, ceramic, elastomers, wood, absorbent material, fibrous material, fibrous material at least partly impregnated with a hardener, fibrous material on a hard backing material, any combination of a fibrous material and another material, and so on.

FIG. 4A shows a disc-shaped topical press, disc 38, having an open passage, receiver 40, to receive the entry of a sharp 10 into the tissues beyond. In FIG. 4A, receiver 40 is funnel-shaped.

FIG. 4B shows a segmented topical press, segment press 42, comprised of adjacent segments for contacting the tissues. It is preferred that the segment press 42 segments have a simple connection to actuator 18. However, the segment press 42 segments may be connected to actuator 18 by a tunable vibratory phase means. As such, the vibrations of either segment may be tuned to be in or out of phase relative to the other segment to influence tissue desensitization.

FIG. 4C shows a topical press configured as a cap for a sharp 10, cap 44. Sharp 10 is able to pass through the distal end of cap 44 to puncture the tissues. The distal end of cap 44 is penetrable by sharp 10, such as by sharp 10 penetrating a thin area of cap 44, by penetrating a fibrous area of cap 44, by penetrating a porous area of cap 44, by entering a pre-existing minimally-sized receiver 40 in cap 44, by pushing open a small flap, and so on.

It is preferred that at least the exterior surface of the distal end of cap 44 is comprised of an absorbent material, absorbent 46, which is absorbent of coolants, such as a gauze, felt, other fibrous materials, porous materials, and so on.

For a cap 44 associated with a syringe, it is preferred that the syringe barrel, barrel 48, is stored in a first position with respect to cap 44. Barrel 48 may telescope into cap 44, thereby causing sharp 10 to penetrate the tip of cap 44, extend distally from cap 44, and thereby penetrate the tissues to a second position. Barrel 48 may be telescopically withdrawn from cap 44, thereby withdrawing sharp 10 from the tissues and retracting sharp 10 entirely into cap 44, and cap 44 locks into barrel 48 in a sharp-retracted third position. With cap 44 locked into barrel 48, sharp 10 cannot be moved distally again. However, cap 44 may be elastically compressible between an advancing barrel 48 and the tissues, and elastically reboundable as the barrel 48 withdraws so as to cover sharp 10, and so on.

It is preferred that cap 44 remain in contact with the tissues until after sharp 10 is entirely withdrawn into cap 44. As such, the procedure can be completed without sharp 10 being exposed to the user or the patient. In addition, cap 44 facilitates containment of bodily fluids, such as droplets that may be released as sharp 10 withdraws from the tissues.

It is preferred that cap 44 has a locking mechanism with barrel 48, first position lock 50, and third position lock 52. A male lock component, male lock ring 54, is at the distal end of barrel 48. First position lock 50 is a female locking portion that permits male lock ring 54 to release and slide toward distal end of cap 44, such that sharp 10 protrudes through cap 44 and into the tissues at the second position for barrel 48. When the barrel is retracted and moving in a proximal direction, male lock ring 54 slides past first position lock 50, and expands into third position lock 52. The inclined plane of female third position lock 52 mates with the plane of male lock ring 54, preventing the release of male lock ring 54 either proximally or distally. Cap 44 is shown releasably locked with the first position lock 50 engaged with barrel 48.

FIG. 4D shows a cap 44 after retracting sharp 10 through receiver 40 and into cap 44. Cap 44 has slid over first position lock 50, and is non-releasably locked with barrel 48 in third position lock 52. The inclined plane of female third position lock 52 mates with male lock ring 54, preventing the release of male lock ring 54 either proximally or distally. Absorbent 46 shows at the end of cap 44.

FIG. 4E shows a topical press configured for connecting to the tip of a sharp 10, a tip press 56. The receiver 40 of tip press 56 is configured to securely connect to the sharp 10 tip, such as by having a cylindrical configuration with a lumen of specified diameter, an elongated cylindrical lumen where the cylinder protrudes substantially above the surface, or a similar lumen. Tip press 56 may also comprise a protective cover for sharp 10. Absorbent 46 covers the distal end of tip press 56.

It is preferred that tip press 56 provides a degree of resistance to sharp 10 penetration. As such, when sharp 10 is pushed toward the tissues, tip press 56 is first pressed onto the tissue surface prior to sharp 10 pushing through tip press 56 and into the tissues. Configurations of receiver 40 which provide penetration resistance include a lumen of a specific diameter, a lumen with a diameter constriction, a cone with a central lumen, a cone having visualization slits in the side that are open to a central lumen, an area of receiver 40 that is sufficiently thin to be penetrable by a sharp 10, and so on. For a tip press 56 with a penetrable thin area, an open lumen is not formed until after the sharp 10 penetrates receiver 40 to form a lumen.

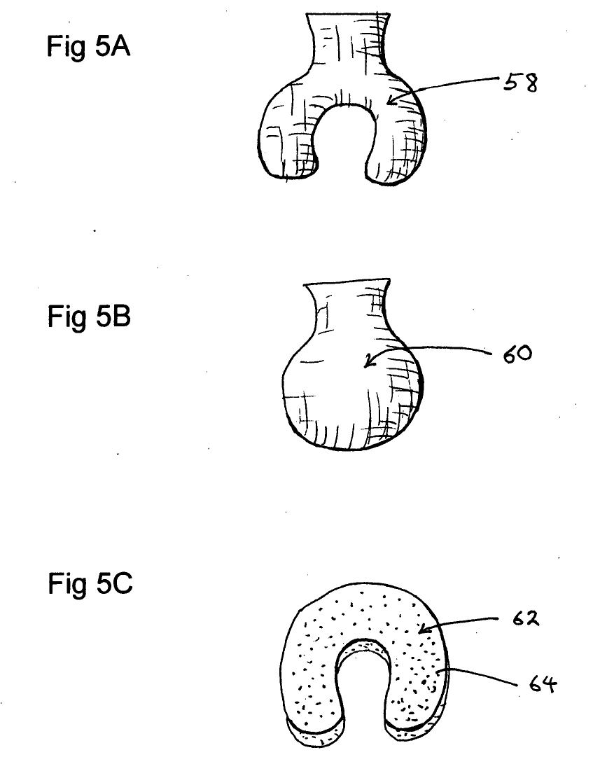

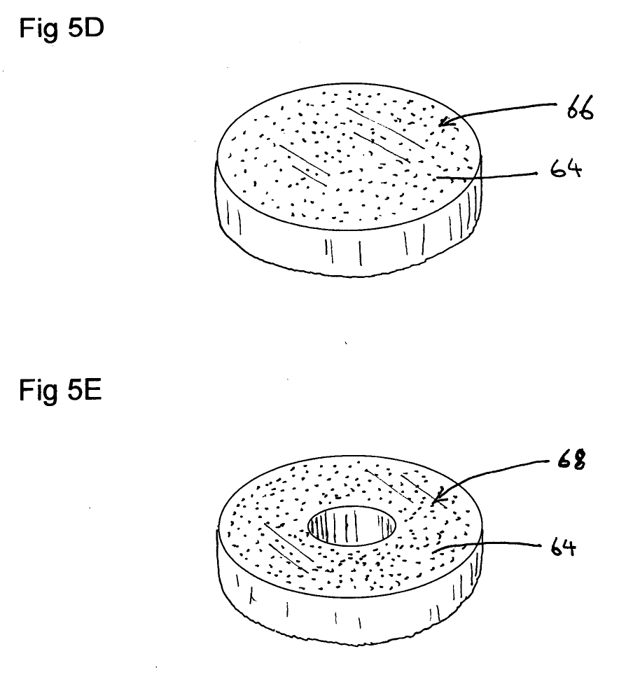

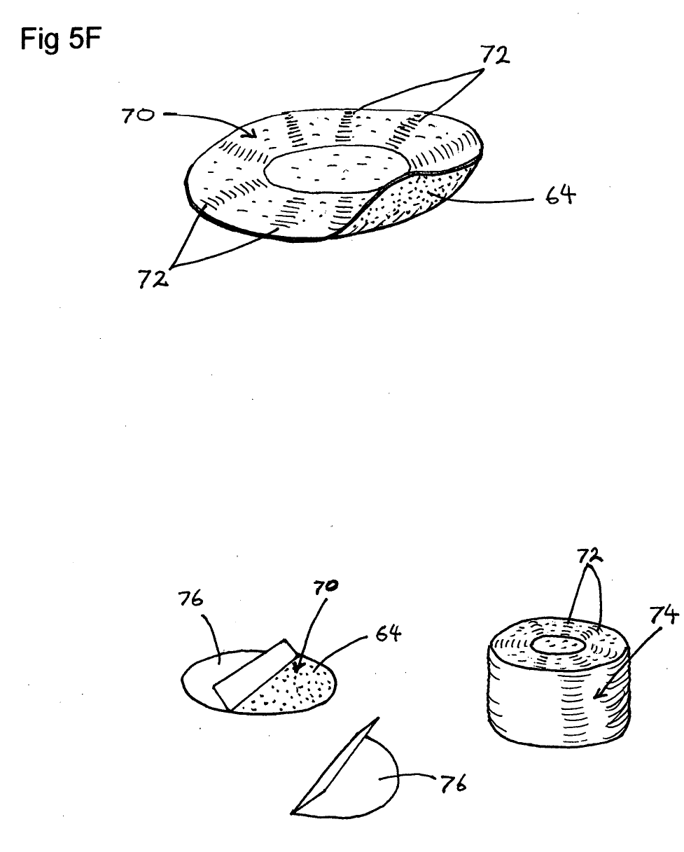

For some applications, it is preferred that at least a portion of the topical press is covered by a cover. FIGS. 5A to 5D show preferred covers for the topical press. It is preferred that covers are comprised of an absorptive, fibrous material. However, the cover may be comprised of plastic, metal, or composites, and so on, and may be arranged in strands, sheets, mesh, foil, fabric, and so on.

A cover fitted to cover slot 16, slot cover 58, is shown in FIG. 5A. Slot cover 58 facilitates visualization of the sharp 10, and permits removal of the topical press from the mouth prior to removal of the sharp 10.

FIG. 5B shows a full cover, full cover 60, for covering a topical press, such as disc 38. It is preferred that full cover 60 has no central lumen. However, full cover 60 may have a lumen that aligns with receiver 40 of disc 38, or a lumen may be made by the user before or after placement on disc 38. Full cover 60 may also be used to cover slot 16 to combine advantages of both. As such, full cover 60 may be used to vibrate and/or cool a puncture point, yet slot 16 can be withdrawn from sharp 10 by sliding out of full cover 60 while full cover 60 remains punctured by sharp 10.

FIG. 5C shows a cover configured to cover only the tissue side of slot 16, slot pad 62. Slot pad 62 is comprised of absorbent materials such as woven material, felts, fibrous material, porous materials, mesh, and so on. Slot pad 62 facilitates visualization of the sharp 10, and permits removal of slot 16 from the puncture area at anytime. It is preferred that slot pad 62 is connected to slot 16 by an adhesive coating, adhesive 64. However, slot pad 62 may connect with molded snaps that grasp the edges of the slot or the outer perimeter of slot 16, and so on.

A cover which covers only the tissue side of disc 38, full pad 66, is shown in FIG. 5D. Full pad 66 is comprised of absorbent materials that permit penetration of a sharp 10 through full pad 66 and into the tissues, such as woven material, felt, fibrous material, foil, sheets, mesh, and so on. It is preferred that full pad 66 is connected to segment press 42 by adhesive 64. However, full pad 66 may connect with molded snaps that grasp the edges of the receiver 40 lumen or the outer perimeter of segment press 42, and so on. Full pad 66 may also simultaneously connect to the separate bars of segment press 42.

FIG. 5E shows a pad with a central lumen, lumen pad 68, connected to disc 38. The central lumen of lumen pad 68 may be aligned with receiver 40 when connected to disc 38. It is preferred that lumen pad 68 is connected to disc 38 by adhesive 64. However, lumen pad 68 may connect with molded snaps that grasp the edges of the lumen or the outer perimeter of disc 38, and so on.

FIG. 5F shows a topical press cover designed to remain over an extraoral puncture area after withdrawal of sharp 10, bandage 70. Bandage 70 has a first side and a second side, wherein the first side contacts the tissues, called the tissue side, and the second side is away from the tissues, called the top side. A substantial portion of the tissue side is coated with adhesive 64 to facilitate adhesion to the tissues prior, during, and after the puncture.

It is preferred that bandage 70 has at least one adhesive-coated area on the top side, spot 72, so as to facilitate adhesion of a bandage 70 to the topical press. It is further preferred that a multiplicity of spots 72 are spaced along the top side perimeter. When a bandage 70 having adhesive 64 and spots 72 are adhered to the topical press is pressed into contact with the tissues, the topical press is thereby transferred to the tissue and adhered to the tissue.

The topical press vibrates the tissues with a higher efficiency than substantially planar vibrators. As the topical press depresses the tissue surface, it nests into the tissue due to a relatively small footprint, thereby engaging the tissue. The topical press vibrations therefore push, pull and massage the tissue, rather than simply sliding or rapping on the surface.

When bandage 70 adheres the topical press to the tissues, the vibration efficiency is further enhanced. Adhered bandage 70 adhesively connects the topical press to the tissues, such that the topical press connectedly vibrates the tissues. Further, when bandage 70 physically contacts the tissue over the actual puncture point, the puncture point is vibrated directly, in addition to vibrating the tissue area surrounding the puncture point.

It is preferred that bandages 38 are supplied in a convenience stack, stack 74, also shown in FIG. 5F. To mount a bandage 70 onto a topical press, the topical press is pressed onto spots 72 of the top bandage 70 of stack 74. Spots 72 adhere to the topical press, and bandage 70 is thereby pulled away from stack 74 when the topical press is withdrawn.

It is preferred that adhesive 64 is removably covered with an adhesion-resistant backing, backing 76. Backing 76 minimizes adhesion between individual bandages 70 in stack 74. Backing 76 therefore increases the likelihood that bandage 70 will pull away from stack 74 when the topical press is withdrawn. Backing 76 is removed immediately prior to puncturing the tissues, thereby exposing adhesive 64. However, adhesion between individual bandages 70 in stack 74 may be minimized without backing 76, such as by providing a bandage 70 having an adhesion-resistant top side similar to backing 76.

As such, bandages 70 have a multiplicity of functions. Bandages 70 form a contamination barrier between the tissues and the topical press, facilitate vibrating the tissues at a puncture area, enhance tissue vibration pain-gate effect, wipe body fluids from the withdrawing sharp 10, and can remain as a dressing over the puncture area.

Bandages 70 may be connected to the topical press by means other than spots 72, such as by utilizing vacuum ports in the topical press, spikes to impale bandage 70, tiny barbs to engage small pores on the top side of bandage 70, a spring-clip, and so on.

When full cover 60, full pad 66, or bandages 70, cover a topical press, they physically contact the tissue at the actual puncture point. As such, when vibrated and/or cooled, full cover 60, full pad 66, or bandages 70, directly vibrate and/or cool the tissues of the puncture point, in addition to vibrating the tissues of the surrounding puncture area.

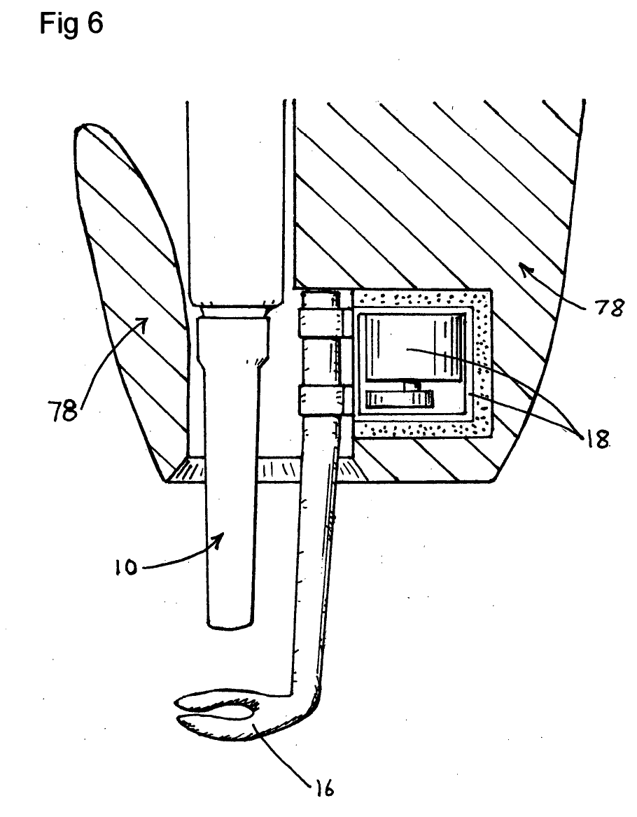

FIG. 6 shows a mechanized injector, needle device 78. After a user activates a switch or triggering mechanism, needle device 78 moves a needle sharp 10 from a first retracted position to a second tissue-penetrating position, injects a medicament through needle sharp 10, and returns needle sharp 10 to a third retracted position. The third position may coincide with the first position. Examples of similar mechanized puncture devices include automatic syringes, automatic glucose lancets, and so on, as shown in US Pat Appl 2002/0082522, and U.S. Pat. Nos. 6,454,743, 6,099,503, and 5,035,704.

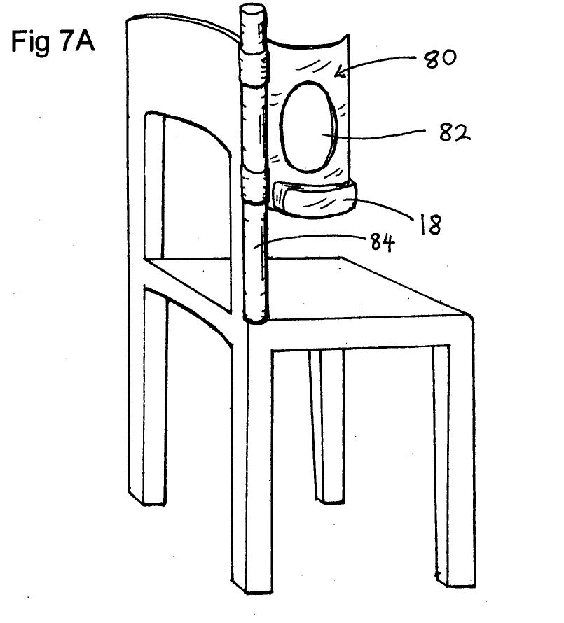

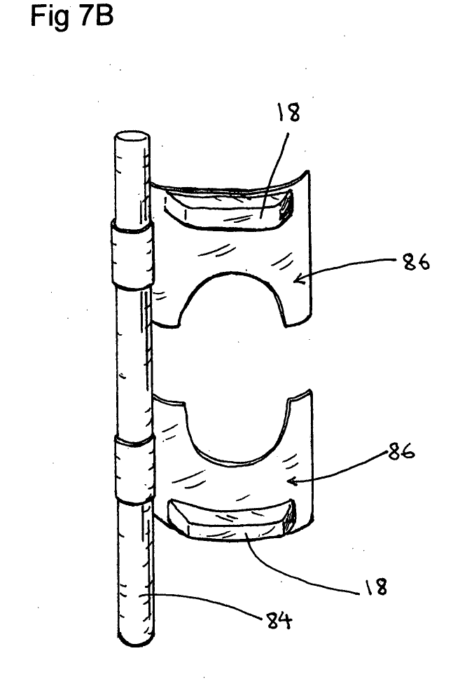

FIGS. 7A and 7B show topical presses which are useful with mechanized puncture devices, such as needle device 78, but are also useful with traditional manual syringes, manual glucose lancets, and so on.

FIG. 7A shows a topical press for contacting a bodily surface, brace 80, having an open access for sharps, access 82, and a connected actuator 18. It is preferred that brace 80 is configured to fit closely against a limb, such as an arm, leg, fingertip, and so on, such that the limb nests into brace 80. It is preferred that brace 80 has a detachable connection, anchor 84, to a stable object, such as a chair, wall, pole, tree, and so on. It is further preferred that the position of brace 80 is adjustable in at least one dimension, such as by moving it along anchor 84, by sliding, ratcheting, clipping, and so on.

FIG. 7B shows another embodiment of a brace press, segment brace 86, connected to actuator 18 and anchor 84. Segment brace 86 is similar to brace 80, but is a set of two separate braces.

Sharp 10 has access to the tissues in the variable area between the brace segments. It is preferred that actuator 18 is capable of vibrating the brace segments in or out of phase with respect to one another, such as by incorporating dedicated actuators 18.

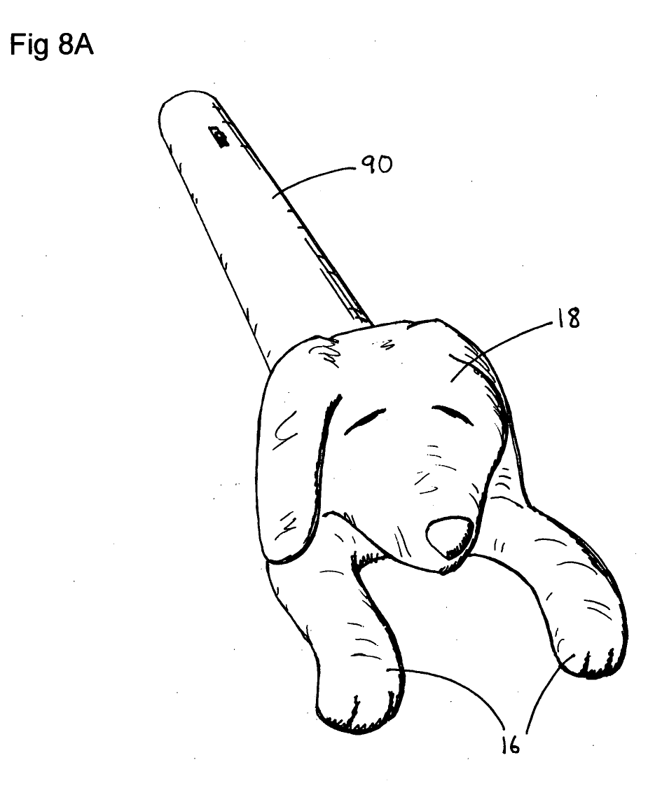

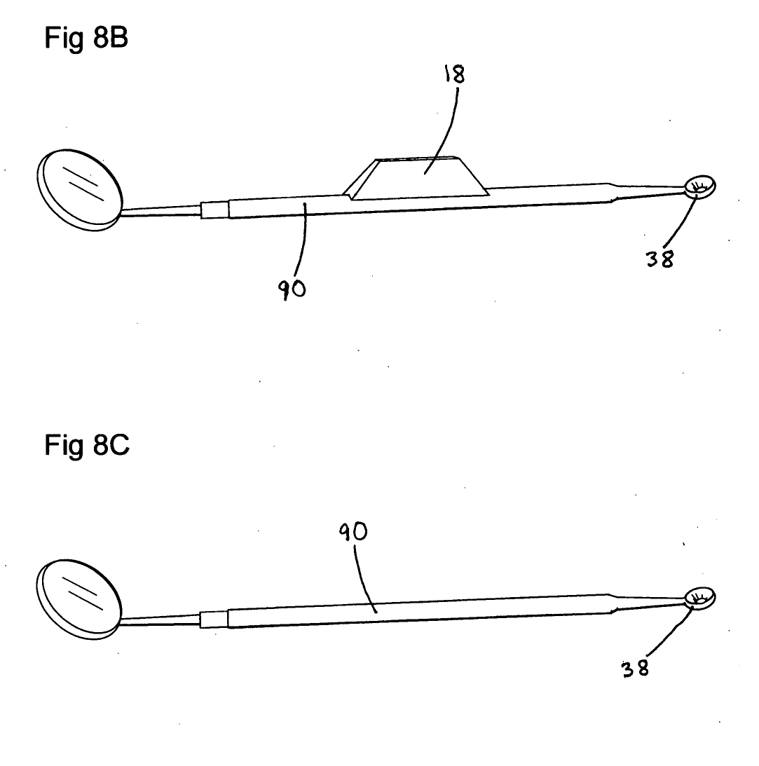

FIGS. 8A to 8C show handheld topical presses.

FIG. 8A shows a handheld vibrating topical press, massager 88 for use with manually operated sharps 10, such traditional syringes, lancets, and so on. Massager 88 is connected to a handle, handle 90, and an actuator 18. Actuator 18 vibrates and/or cools massager 88. It is preferred that massager 88, as well as handle 90, and actuator 18 have a coordinated appearance resembling a child's toy, so as to reduce children's fear. The toy shown in FIG. 8A shows a slot 16 configured as an animal's paws.

For intraoral use, smaller topical presses are required. FIG. 8B shows a topical press with an actuator 18 connected to handle 90, for vibrating and/or cooling intraoral tissues. It is preferred that actuator 18 is nondetachably connected to handle 90. However actuator 18 may be detachably connected to handle 90.

A coolant actuator 18 is comprised of a refrigeration system. An example of a coolant actuator 18 comprises a contained vapocoolant, an intake valve, a release valve, and a tubing to full pad 66 on disc 38, wherein opening the valve releases vapocoolant onto full pad 66, thereby cooling full pad 66. However, a coolant actuator 18 may comprise a small refrigeration compressor and fan system, or intake and release valves for externally supplied liquid or gas coolants from a remote refrigeration system, and so on.

FIG. 8C shows an intraoral topical press hand instrument having a handle 90 connected to disc 38.

It is preferred that the opposite end of handle 90 is connected to an instrument that is different than disc 38, such as a mouth mirror. However, handle 90 may be connected to a second disc 38, such as a disc 38 set at an angle different from a first disc 38, or any other instrument.

From the description above, a number of advantages of the topical press become evident:
(a) The topical press is able to substantially reduce tissue sensitivity to control pain
(a) It is simple to use
(b) The topical press is time efficient
(c) The topical press can decrease patient apprehension

### OPERATION

### FIGS. 1-8

By using the topical press of the invention, it is now possible, surprisingly, to achieve substantial reduction in puncture discomfort within seconds.

The process offers the advantage that the user can now puncture the tissues simply and economically.

In a further embodiment of the invention, there are multiple applications of the method for desensitizing the tissues with a topical press and puncturing with a sharp 10.

### EXAMPLE 1

For a periodontal ligament injection, a user selects a handpiece 14 having an injector 12 and a slot 16 with an absorbent surface, as shown in FIG. 1. A local anesthetic cartridge is loaded into the medicament chamber. Actuator 18 is turned on to vibrate slot 16. A refrigerant is applied to the surface of slot 16. A few seconds are allowed to elapse until the slot 16 surface appears frosty.

Slot 16 is inserted into the gingival sulcus of a tooth and pressed against the tissue puncture area by partly compressing the resiliency means of handpiece 14. Handpiece 14 rotates injector 12, and anesthetic is pumped from the anesthetic cartridge, into tube 30, into bore, and flowing out orifice 34. By further compressing the resiliency means, handpiece 14 is advanced toward the tissues until rotating injector 12 punctures the tissues.

Anesthetic is pumped under pressure from orifice 34 and into the ligament space as injector 12 penetrates the ligament. The anesthetic flow anesthetizes the tissues and prevents debris from entering into orifice 34. Anesthetic continues to flow as injector 12 advances into the ligament. Injector 12 tends to seal the tissue hole created by the advancing injector 12, thereby creating a backpressure of anesthetic. The backpressure causes the anesthetic to flow distally from orifice 34 toward the distal tip of injector 12, and into the ligament.

Injector 12 is advanced until shoulder 36 seats into the sulcus, as shown in FIG. 3. Shoulder 36 further seals the puncture hole to fluid backpressure, and facilitates diffusion of anesthetic toward the tooth apex. A sufficient volume of anesthetic is pumped into the ligament so as to diffuse through the cortical plate, into the medullary bone, and to the apex of the tooth. Injector 12 is counter-rotated out of the puncture site. Handpiece 14 is removed from the area.

### EXAMPLE 2

For an injection, a user selects a needle device 78 having an actuator 18, as shown in FIG. 6.

Needle device 78 has a segment press 42, as shown in FIG. 4B. A disposable syringe having a needle sharp 10 is preloaded with a medicament is placed in needle device 78. Needle device 78 is oriented perpendicularly over a skin puncture area and segment press 42 is pressed into contact with the skin.

Needle device 78 is turned on. Actuator 18 begins to vibrate segment press 42, and segment press 42 vibrates the skin of the puncture area. Sharp 10 is moved toward the skin, and penetrates the vibrating tissue injection site between the vibrating segments of segment press 42 to a preset depth. Needle device 78 injects the medicament. After the injection is complete, sharp 10 is withdrawn from the tissues and actuator 18 turns off. Needle device 78 is lifted from the skin.

### EXAMPLE 3

For an injection, a user selects a needle device 78 and a segmented brace 86 topical press. Actuator 18 is connected to both segments. Segmented brace 86 and needle device 78 are connected to a chair utilizing anchor 84, as shown in FIG. 7B.

A disposable syringe with a needle sharp 10 is preloaded with a medicament and placed in needle device 78. The patient is seated in the chair with shoulder bared. The position of segmented brace 86 is adjusted to the patient's height by sliding segmented brace 86 along anchor 84. The patient's shoulder is nested into of segmented brace 86.

Actuator 18 and needle device 78 are turned on. Actuator 18 vibrates the two segments of segmented brace 86, which vibrates the skin of the puncture area. Needle device 78 moves sharp 10 toward the shoulder. Sharp 10 penetrates the vibrating puncture point between the vibrating segments of segmented brace 86 to a preset depth. Needle device 78 injects the medicament.

After the injection is complete, sharp 10 is withdrawn from the tissues and actuator 18 turns off.

### EXAMPLE 4

For an injection, a user selects a needle device 78 having an actuator 18, and a disc 38, as shown in FIG. 4A. A syringe with a needle sharp 10 is preloaded with a medicament and placed in needle device 78. The user presses needle device 78 perpendicularly onto adhesive spots 72 of a bandage 70 at the top of stack 74, as shown in FIG. 5F, such that spots 72 adhere to disc 38. As the user withdraws needle device 78 from stack 74, adhered spots 72 lifts the top bandage 70 with its backing 76 away from stack 74. As such, bandage 70 covers disc 38, thereby preventing direct contact of disc 38 with the skin during use. Backing 76 is removed from adhesive 64 of bandage 70, exposing adhesive 64.

Needle device 78 is oriented perpendicularly to the surface of the skin. Needle device 78 is pressed onto the skin so that disc 38 contacts the skin with bandage 70 interposed. Adhesive 64 adheres bandage 70 to the skin.

Needle device 78 is turned on. Actuator 18 begins to vibrate disc 38 and bandage 70, which in turn vibrates the skin and the puncture area. Sharp 10 moves toward the skin, penetrating bandage 70 and the vibrating tissue at the puncture point. Needle device 78 injects the medicament.

Actuator 18 turns off, the needle is withdrawn from the tissues, through bandage 70, through disc 38, and up into needle device 78. Needle device 78 is lifted from the skin. As needle device 78 is lifted from the skin, the adhesion of bandage 70 to the skin is greater than the adhesion of spots 72 to disc 38. Therefore bandage 70 pulls away from disc 38, and remains adhered to the skin.

### EXAMPLE 5

For an injection, a user selects a needle device 78 having an actuator 18, a preloaded syringe, and a cap 44, as shown in FIG. 4C. An absorbent surface of cap 44 is sprayed with a refrigerant. Needle device 78 is oriented perpendicularly over a tissues puncture area and cap 44 is pressed into contact with the tissues.

Needle device 78 is turned on. Actuator 18 vibrates cap 44, and cap 44 vibrates the tissues of the puncture area. The refrigerant spray cools the tissue. Needle device 78 releases first position lock 50 by pushing the syringe barrel and the sharp 10 needle telescopically into cap 44. Sharp 10 penetrates the distal end of cap 44 and punctures the tissues to a preset depth at the second position. Needle device 78 stabilizes the barrel at the second position, and pushes the syringe plunger until the medicament is injected.

Needle device 78 telescopically withdraws the barrel from cap 44, and withdraws sharp 10 from the tissues until sharp 10 is retracted entirely into cap 44. As sharp 10 is fully retracted, the male component of the lock slides over first position lock 50, and expands into third position lock 52, thereby locking cap 44 into the barrel in the sharp-retracted position. Cap 44 cannot be moved distally again, as shown in FIG. 4D. Actuator 18 turns off. Needle device 78 is lifted from the tissues.

### EXAMPLE 6

A user selects a tip press 56 having a tissue side covered with absorbent fibers, as shown in FIG. 4E. A sharp 10 is inserted into receiver 40 of tip press 56 until it encounters a thin sheet occluding the lumen, whereupon the insertion is halted. Sharp 10 does not protrude from the tissue side of tip press 56. A vapocoolant is sprayed onto the absorbent tissue side of tip press 56. After a few seconds the absorbent side appears frosty. Frosty tip press 56 is carried on sharp 10 to the puncture site, and is held against the tissues for a few seconds to cool the tissues. Sharp 10 is pushed through the thin occluding sheet, emerges from tip press 56, and punctures the tissues. The procedure is completed, such as an injection, and then sharp 10 and tip press 56 are removed from the tissues.

### EXAMPLE 7

User selects a topical press massager 88 with the outer appearance of a puppy with front paws extended forward, as shown in FIG. 8A. Actuator 18 is turned on to vibrate primarily the front paws. The vibrating front paws are placed on the skin of a child to desensitize the skin with vibrations. The appearance of massager 88 partly allays the child's fears. A sharp 10 is used to puncture the skin, such as a manual syringe, and is removed.

### EXAMPLE 8

A topical press hand instrument having a disc 38 on a first end and a mirror on a second end is frequently used by a user as a mouth mirror, as shown in FIG. 8C. Prior to a palatal injection, an adhesive full pad 66 is removed from a backing paper and adhered to the tissue side of a disc 38, as shown in FIG. 5D. A vapocoolant is sprayed onto full pad 66. After a few seconds, the surface of full pad 66 appears frosty. Full pad 66 is firmly held against the tissues for a few seconds to cool the tissues, thereby reducing tissue sensitivity. A sharp 10 needle is inserted through receiver 40, through full pad 66, and into the tissues. A few drops of local anesthetic are deposited. The topical press is lifted from the tissues by sliding disc 38 with full pad 66 up the sharp 10 needle shaft toward the hub. After depositing additional local anesthesia, the user removes the sharp 10 needle and the topical press from the mouth.

### EXAMPLE 9

A user selects a topical press hand instrument having a slot 16. A slot cover 58 is stretched snugly over slot 16, as shown in FIG. 5A. A vapocoolant is sprayed onto slot cover 58. After a few seconds, the surface of slot cover 58 appears frosty. Slot 16 with frosty slot cover 58 is firmly held against the tissues for a few seconds to cool the tissues. A sharp 10 is inserted through slot 16 and into the tissues. After a few seconds, the user pulls slot 16 away from the inserted sharp 10, and withdraws the topical press from the mouth. After the procedure, sharp 10 is removed from the tissues, and from the mouth.

### EXAMPLE 10

A topical press having a metal disc 38, as shown in FIG. 8B, is stored on a frozen block, such as ice. The cold topical press and frozen block are removed from the freezer and placed within reach of the user. The user turns on vibrating actuator 18, and firmly holds the cold disc 38 against an oral puncture area to simultaneously cool and vibrate the tissues. A sharp 10 penetrates the tissues through receiver 40. Sharp 10 is removed from the tissues. Sharp 10 and the topical press are removed from the mouth.

### SUMMARY, RAMIFICATIONS AND SCOPE

Accordingly, the reader will see that the topical press of this invention is able to substantially control pain associated with minor tissue trauma and punctures. Furthermore, the topical press and method have the additional advantages in that it permits pain control in just a few seconds.

Although the description above contains many specificities, these should not be construed as limiting the scope of the invention and process, but as merely providing illustrations of some of the presently preferred embodiments of this invention.

For a first example, needle device 78 is shown with needle sharps 10. However, it can be adapted for use with other sharps 10.

For a second example, handpiece 14 can be improved to include a computerized medicament pump, battery power, a vibrator for injector 12, an onboard coolant system for the topical press, and so on.

Thus the scope of the invention should be determined by the appended claims and their legal equivalents, rather than by the examples given.

I claim:

1. A method for injecting a medicament into the periodontal ligament of a tooth comprising the steps of drilling into the ligament with a drill bit having a central bore, injecting medicament through said bore and into the ligament, and removing said bit from the ligament.

2. A tissue puncture method comprising the steps of supporting a sharp with respect to a topical press, vibrating and/or cooling a tissue puncture area with said topical press, or cover thereof, puncturing the tissues with said sharp at a puncture point within the vibrating and/or cooled puncture area, and withdrawing said sharp from the puncture point.

3. A tissue puncture method comprising the steps of supporting a sharp with respect to a topical press, said topical press having an opening therethrough for passage of said sharp, directly vibrating and/or cooling a tissue puncture point with said topical press or cover thereof, puncturing the vibrating and/or cooling tissues at the puncture point with said sharp, and withdrawing said sharp from the tissues.

4. A tissue puncture method comprising the steps of supporting a sharp with respect to a topical press surface or cover thereof, directly vibrating and/or cooling a tissue puncture point with said topical press or cover thereof, puncturing said topical press surface or cover thereof, puncturing the vibrating and/or cooling tissue puncture point with said sharp, and withdrawing said sharp from the tissues.

5. A tissue puncture method comprising the steps of directly vibrating and/or cooling a tissue puncture point with a topical press or cover thereof, puncturing the vibrating and/or cooling the tissue puncture point with a sharp, and withdrawing said sharp from the tissues.

6. A tissue puncture method comprising the steps of vibrating a tissue area which substantially encompasses a puncture point, puncturing the vibrating tissue area at the puncture point with a sharp, and withdrawing said sharp from the puncture point.

7. A tissue puncture method comprising the steps of cooling a tissue area which substantially encompasses a puncture point utilizing a coolant-absorbent surface, puncturing the cooling puncture point with a sharp, and withdrawing said sharp from the puncture point.

8. A tissue puncture method comprising the steps of cooling a tissue puncture area with a cold topical press or cover thereof, inserting a sharp into and through said topical press and into the cooling tissues of the puncture area, and withdrawing said sharp from the tissues.

9. The methods of claims 2, 3, 4, 5, 7, and 8, wherein the tissue cooling device utilizes a vapocoolant with a boiling point between −1 C and −30 C.

10. The methods of claim 9, wherein the coolant is 1,1,1,2,3,3,3-heptafluoropropane

11. The method of claim 9, wherein the coolant is 1,1,1,3,3,3-hexafluoropropane

12. The method of claims 2, 3, 4, and 5, wherein said cover is a bandage.

13. The method of claim 12, wherein said bandage has adhesive on two sides.
